(19) United States
(12) Patent Application Publication
(10) Pub. No.: US 2014/0240707 A1
(43) Pub. Date: Aug. 28, 2014

(54) FILM MEASUREMENT APPARATUS AND METHOD OF MEASURING FILM

(71) Applicant: KABUSHIKI KAISHA TOSHIBA, Minato-ku (JP)

(72) Inventor: Toru KOIKE, Mie-ken (JP)

(73) Assignee: KABUSHIKI KAISHA TOSHIBA, Minato-ku (JP)

(21) Appl. No.: 14/024,959

(22) Filed: Sep. 12, 2013

(30) Foreign Application Priority Data
Feb. 28, 2013 (JP) 2013-038975

(51) Int. Cl. G01N 21/27

(52) U.S. Cl. CPC G01N 21/27
USPC 356/402

(57) ABSTRACT

An aspect of the present embodiment, there is provided a film measurement apparatus including an optical processing unit configured to irradiate a substrate with light, the substrate including a multi-layered film thereon, an electrical processing unit configured to be inputted measurement spectrum of reflection light reflected from the substrate, to calculate a film parameter of each of layers in a stacked structure of the multi-layered film by matching plural times between the measurement spectrum and theoretical spectrum theoretically calculated on a basis of the stacked structure, to set each of links to a film parameter of each layer having a same film in the multi-layered film, to calculate a representative film parameter in each of the links, and to calculate the film parameter of each of the layers corresponding to the representative film parameter.

### CROSS REFERENCE TO RELATED APPLICATION

This application is based upon and claims the benefit of priority from prior Japanese Patent Application No. 2013-038975, filed on Feb. 28, 2013, the entire contents of which are incorporated herein by reference.

### FIELD

Exemplary embodiments described herein generally relate to a film measurement apparatus and a method of measuring a film.

### BACKGROUND

Recently, stacked non-volatile memory has been focused to realize higher bit density in a technical field of semiconductor memory devices. In the stacked non-volatile memories, memory cells are three-dimensionally stacked. In fabricating process of the stacked non-volatile memory, silicon films and silicon oxide films, for example, are repeatedly stacked on a substrate so that a stacked layer is constituted as a multi-layered film. The multi-layered film is processed to generate a plurality of memory cells.

It is principally desirable to integrally provide each layer in such a structure of the multi-layered film. However, each of film thicknesses is demanded to control each layer. On the other hand, when a number of layers in the multi-layered film are increased to obtain higher integration, two problems mentioned below are generated in calculating the film thicknesses to be described below.

First, an analysis period is increased. Increasing a number of stacked layers cause to increase unknown film parameters, for example, film thicknesses, refractive indexes and film qualities determined by refractive index and attenuation coefficient. Accordingly, the analysis period rises in an exponential fashion.

Secondly, calculation accuracy of the film thicknesses is degraded. The calculation of the film parameters is conducted by irradiating a substrate with light and measuring reflection light from the substrate to input the measurement spectrum into a computer, for example. In a case of comparing real measurement value with the target film thickness of the processing apparatus, it is clearly demonstrated that errors are dramatically increased with increasing the film parameters.

### BRIEF DESCRIPTION OF THE DRAWINGS

FIG. 1 is a block diagram showing an electrical and optical constitution of a measurement apparatus according to a first embodiment;

FIG. 2 is a cross-sectional view of a stacked structure showing a multi-layered film which is measured by the measurement apparatus according to the first embodiment;

FIG. 3 is a cross-sectional view of the multi-layered film showing grouping odd-ordered layers according to the first embodiment;

FIG. 4 is a cross-sectional view of the multi-layered film showing grouping even-ordered layers according to the first embodiment;

FIG. 5 is a flow chart showing conceptually processing steps of calculating a film thickness of each film in the multi-layered film according to the first embodiment;

FIG. 6 is a table showing representative film thicknesses of silicon oxide films according to the first embodiment;

FIG. 7 is a table showing representative film thicknesses of amorphous silicon films according to the first embodiment;

FIG. 8 is a graph showing the film thickness of each of the silicon oxide films according to the first embodiment;

FIG. 9 is a graph showing the film thickness of each of the amorphous silicon films according to the first embodiment;

FIG. 10 is a graph showing an analysis time of the multi-layered film using a number of stacked layers as a parameter according to the first embodiment;

FIG. 11 is a graph showing an accuracy of the multi-layered film using a number of the stacked layers as a parameter according to the first embodiment;

FIG. 12 is a flow chart showing conceptually processing steps of calculating a film thickness of each film in a multi-layered film according to a second embodiment;

FIG. 13 is a cross-sectional view of the multi-layered film showing a concept of calculating the film thickness according to the second embodiment;

FIG. 14 is a cross-sectional view of the multi-layered film showing the concept of calculating the film thickness according to the second embodiment;

FIG. 15 is a cross-sectional view of the multi-layered film showing the concept of calculating the film thickness according to the second embodiment;

FIG. 16 is a graph showing the film thickness of each of the silicon oxide films according to the second embodiment;

FIG. 17 is a graph showing the film thickness of each of the amorphous silicon films according to the second embodiment;

### DETAILED DESCRIPTION

An aspect of the present embodiment, there is provided a film measurement apparatus including an optical processing unit configured to irradiate a substrate with light, the substrate including a multi-layered film thereon, an electrical processing unit configured to be inputted measurement spectrum of reflection light reflected from the substrate, to calculate a film parameter of each of layers in a stacked structure of the multi-layered film by matching plural times between the measurement spectrum and theoretical spectrum theoretically calculated on a basis of the stacked structure, to set each of links to a film parameter of each layer having a same film in the multi-layered film, to calculate a representative film parameter in each of the links, and to calculate the film parameter of each of the layers corresponding to the representative film parameter.

An aspect of another embodiment, there is provided a method of measuring a film, including calculating a film parameter of each of layers in a multi-layered film by matching theoretical spectrum and measurement spectrum, the theoretical spectrum being calculated on a basis of a stacked structure of the multi-layered film, the measurement spectrum being obtained by measurement of the multi-layered film including irradiating a substrate with light, the substrate including a multi-layered film thereon to acquire measurement spectrum of reflection light reflected from the substrate, setting each of links to a film parameter of each layer having a same film in the multi-layered film, calculating a representative film parameter in each of the links, calculating the film parameter of each of the layers in the multi-layered film corresponding to the representative film parameter.

Embodiments will be described below in detail with reference to the attached drawings mentioned above. Throughout the attached drawings, similar or same reference numerals show similar, equivalent or same components, and the description is not repeated. Consequently, technical features of each embodiment are mainly described.

### First Embodiment

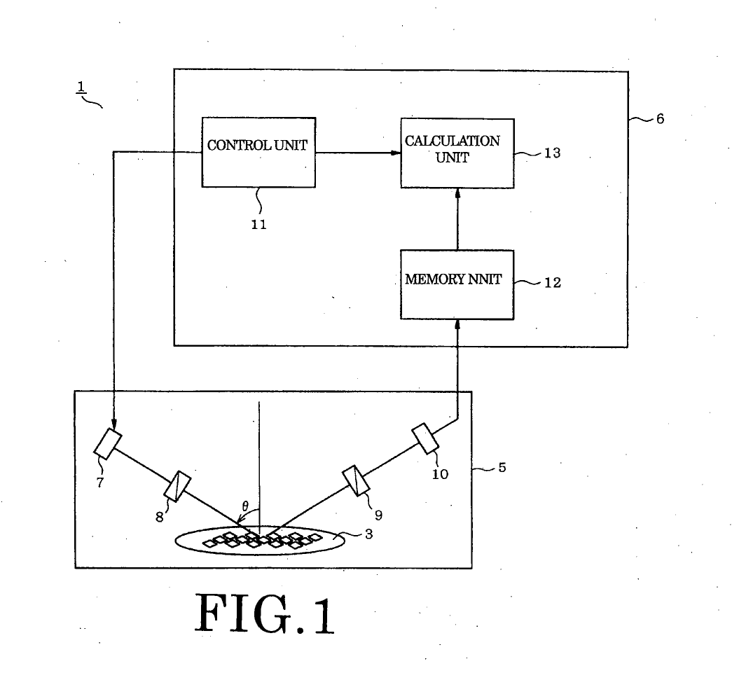

As shown in FIG. 1, a measurement apparatus 1 (film measurement apparatus) is placed in a fabricating line in which semiconductor devices, stacked non-volatile memories or the like, for example, are fabricated. The stacked non-volatile memory includes a structure in which memory cells are three-dimensionally stacked layer. Conductive films and insulators are repeatedly on a substrate to be formed as the stacked layer. Successively, this multi-layered film is processed to be formed of a lot of the memory cells.

The measurement apparatus 1 is placed in the fabricating line together with processing apparatuses, such as a CVD (Chemical Vapor Deposition) apparatus, an etching apparatus and the like. The measurement apparatus 1 can be set in such the processing apparatuses. A fabricating process due to the processing apparatuses is conducted described below. Insulating films and conductive films are repeatedly stacked on a substrate, for example, a semiconductor wafer, to be provided as a stacked layer. The multi-layered film, which is the films is stacked, is patterned to be a desired feature.

The measurement apparatus 1 is placed to verify film qualities or the like after processes in which layers are repeatedly stacked are conducted. It is verified that each layer in the multi-layered film is stacked with a target film thickness and film qualities determined by refractive index n and optical constant of attenuation coefficient k in halfway of the process, or not. A measurement object 2 verified by the measurement apparatus 1 is a deposition structure of the multi-layered film formed in CVD apparatus. A process structure of the multi-layered film processed after the deposition can be set as the measurement object 2.

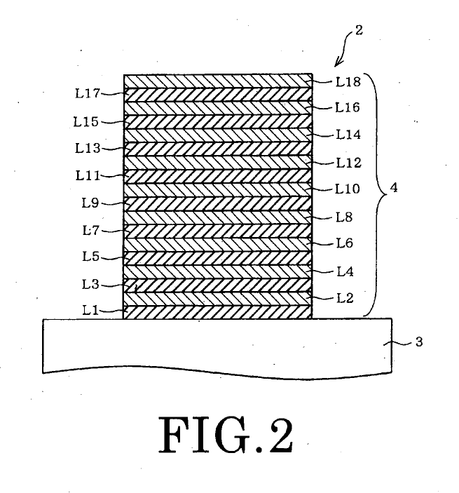

As shown schematically in FIG. 2 as the vertically cross-sectional view, the measurement object 2 verified by the measurement apparatus 1 is set to be the multi-layered film 4 having a deposition structure of N layers on the substrate 3, where N is an even natural number, eighteen layers L1-L18 in the first embodiment. The multi-layered film 4 is constituted with eighteen layers in which different kinds of two layers are alternately stacked. A silicon oxide films are stacked as odd-ordered N/2 layers L1, L3, L5-L17, and an amorphous silicon films are stacked as even-ordered N/2 layers L2, L4, L6-L18.

As shown in FIG. 1, non-destructive spectrographic elliptical polarization analysis can be conducted in the measurement apparatus 1 which called ellipsometer. The measurement apparatus 1 functionally includes an optical processing unit 5 and an electrical processing unit 6. The optical processing unit 5 includes an optical source 7, a polarizer 8, an analyzer 9 and a detector 10. The electrical processing unit 6 includes a personal computer, for example. The processing unit 6 is a block configured to control output of light by the optical source 7, to calculate a result of detection by the detector 10 and to electrically process, further, functionally includes a controlling unit 11, a memory unit 12 and a calculating unit 13.

The optical source 7 irradiates with white light corresponded to the control of the controlling unit 11, for example. The white light is polarized by the polarizer 8. The polarizer 8 decomposes a polarization direction into a horizontal component and a vertical component to an incident surface, and enters the light into a surface of the substrate 3, a semiconductor wafer, which is the measurement object 2, at an incident angle θ. The measurement object 2 can reflect the light, which is the reflection light to be polarized. The reflection light enters into the detector 10 through the analyzer 9 so that the detector 10 detects the reflection light. In such a manner, strength ratio and phase difference between the horizontal polarization component and the vertical polarization component of the reflection light can be obtained.

The memory unit 12 configured to store the detection results of the detector 10 every wavelength. The measurement result corresponded to shift of measurement wavelength, which is called measurement spectrum, by the detector 10 can be recorded by the memory unit 12 by using such the non-distractive detection approach. The calculating unit 13 performs to calculate corresponded to the control of the controlling unit 11 by using the measurement spectrum stored in the calculating unit 13.

Effects of the constitution mentioned above are described below. Information being necessary to detect and measure is inputted in the controlling unit 11 by using a recipe, and the calculating unit 13 conducts calculating on a basis of the information provided by the controlling unit 11.

The information which is provided in the controlling unit 11 and the calculating unit 13 includes parameters on the substrate 3, the structure of the measurement object 2 and material information of each layer L1-L18 of the multi-layered film 4. The parameters includes a measurement area, a measurement coordinate, a measurement direction on the substrate, a wavelength area of the optical source 7 (visible light area and/or infrared light area), for example, the structure of the measurement object 2, material information of each layer in the multi-layered film 4 constituting the measurement object 2, and grouping information linking the film parameters of the same films such as the film thicknesses and the film qualities determined by optical constant of refractive index n and attenuation coefficient k.

The structure and material information of the measurement object 2 are different from every process condition to form each layer in the multi-layered film. The material information corresponded to the process condition used in each layer in the multi-layered film 4 is entered by every layer.

When information such as an order of the stacked layers on the substrate 3, a number of the stacked layers and the film quality of each layer of the multi-layered film 4 is entered, the calculating unit 13 can analyze these transmission, attenuation ratio, reflection ratio of the interface or the like in each layer to theoretically calculate theoretical spectrum.

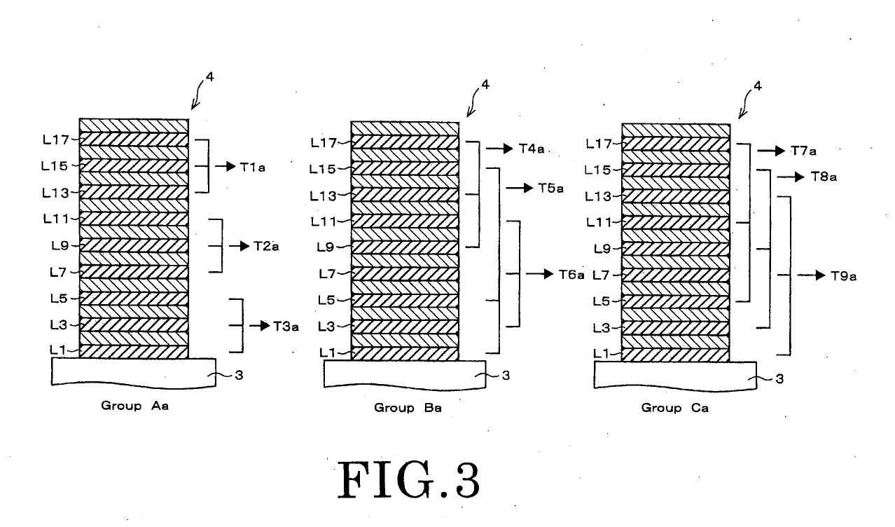

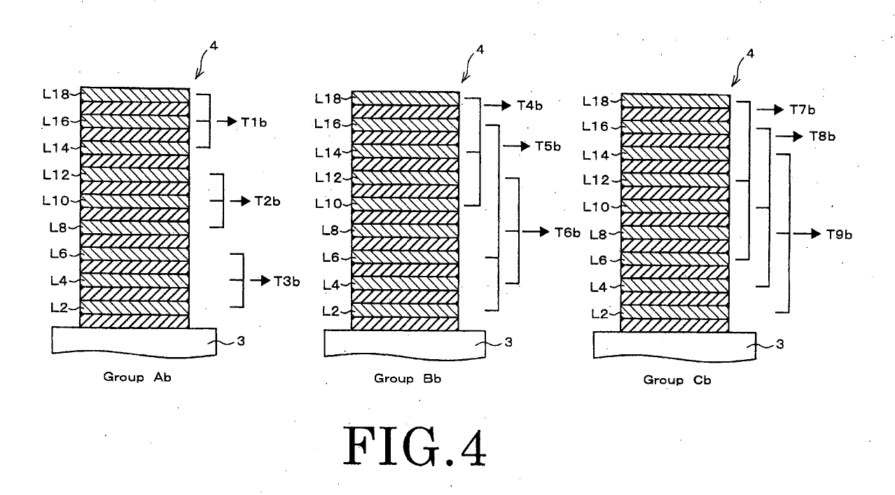

Grouping information is explained below. The grouping information reveals grouping of same films in the multi-layered film 4 and linking of m parameters, for example, a film thickness and/or film qualities, in the stacked structure of the multi-layered film 4, where m is a divisor of N/2, and two or larger than two and smaller than N/2. FIGS. 3, 4 show grouping of the stacked structure of the multi-layered film 4 with eighteen layers, as example.

As shown in FIG. 2, each of the layers L1-L18 in the multi-layered film 4 with eighteen layers is stacked on the substrate 3 in order. For convenience on explaining, grouping of odd-ordered layers L1, L3-L17 is shown in FIG. 3, for example, and grouping of even-ordered layers L2, L4-L18 is shown in FIG. 4, for example.

The odd-ordered layers L1, L3-L17 of the multi-layered film 4 shown in FIG. 3, each film is composed of silicon oxide. On the other hand, the even-ordered layers L2, L4-L18 of the multi-layered film 4 shown in FIG. 4, each film is composed of amorphous silicon.

The odd-ordered layers L1, L3-L17 in FIG. 3 are preliminarily grouped for three (corresponding to N/(2×m)) groups Aa, Ba, Ca. Three film parameters are set in a link T1a, each of the film parameters is composed of the same film in the group Aa. Further, other layers are set in a link T2a and a link T3a, each of the layers are not overlapped with other layers in other links, for example, the layers L13, L15 and L17 of the link T1a. As shown in FIG. 3, the group Aa is constituted with three links, which is corresponded to m links, links T1a, T2a and T3a, where the links T1a includes the layer L13, L15, L17, the link T2a includes the layer L7, L9, L11, and the link T3a includes the layer L1, L3, L5.

The group Ba is set as a combination of different layers from the layers in the group Aa. Namely, three film parameters are set in a link T4a, and each of the three film parameters are composed of the same film. As a result, the link T4a includes the layer L9, L13, L17. Other than the layer L9, L13, L17 are set in links T5a, T6a in order so that one layer in one link is not overlapped with other layers in other links, for example, the layer L9, L13, L17 in the link T4a. As shown in FIG. 3, the group Ba is constituted with three (corresponding to N/(2×m)) links T4a, T5a and T6a, where the links T4a includes the layer L9, L13, L17, the link T2a includes the layer L1, L5, L15, and the link T3a includes the layer L3, L7, L11.

Furthermore, the group Ca is set as a combination of different layers from the layers in the groups Aa, Ba. Namely, three film parameters are set in a link T7a, and each of the three film parameters are composed of the same film. As a result, the link T7a includes the layer L5, L11, L17. Other than the layer L5, L11, L17 are set in links T8a, T9a in order so that one layer in one link is not overlapped with other layers in other links, for example, the layer L5, L11, L17 in the link T7a. As shown in FIG. 3, the group Ca is constituted with three (corresponding to N/(2×m)) links T7a, T8a and T9a, where the links T7a includes the layer L5, L11, L17, the link T8a includes the layer L3, L9, L15, and the link T9a includes the layer L1, L7, L13.

On the other hand, each of in the odd-ordered layers L1, L3, L5-L17 is assigned in one time in each of the groups. Therefore, when the layers L1, L3, L5-L17 are grouped into three groups Aa, Ba, Ca, each of the layers L1, L3, L5-L17 is linked three times.

As same as the odd-ordered layers described above, the even-ordered layers L2, L4-L18 as shown in FIG. 4 are constituted with three (corresponding to N/(2×m)) groups Ab, Bb, Cb. A method of grouping these film parameters to constitute links is the same as the grouping of the odd-ordered layers L1, L3-L17 described above. Accordingly, explanation in detail of the grouping is omitted.

FIG. 4 specifically shows constitutions as mentioned below. The group Ab is constituted with three (corresponding to N/(2×m)) links T1b, T2b, T3b, where the links T1b includes the layer L14, L16, L18, the link T2b includes the layer L8, L10, L12, and the link T3b includes the layer L2, L4, L6. The group Bb is constituted with three (corresponding to N/(2×m)) links T4b, T5b, T6b, where the links T4b includes the layer L10, L14, L18, the link T5b includes the layer L2, L6, L16, and the link T6b includes the layer L4, L8, L12. The group Cb is constituted with three (corresponding to N/(2×m)) links T7b, T8b, T9b, where the links T7b includes the layer L6, L12, L18, the link T8b includes the layer L4, L10, L16, and the link T9b includes the layer L2, L8, L14. Such the grouping information is inputted in the controlling unit 11.

The groups Aa, Ba, Ca in the odd-ordered layers L1, L3-L17 are explained below, while the groups Ab, Bb, Cb are omitted to be explained.

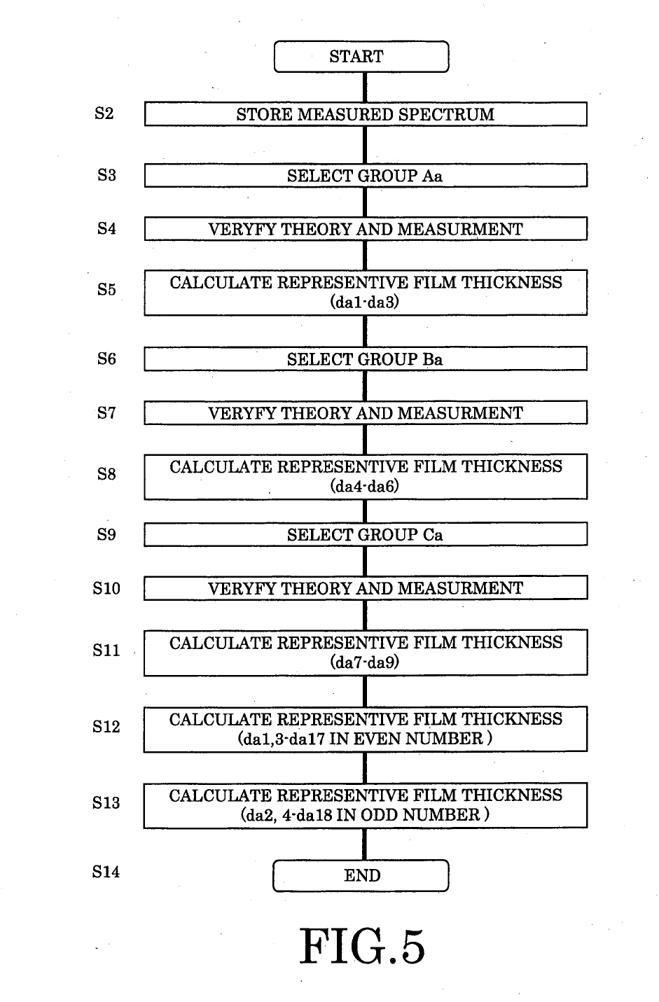

FIG. 5 is a flow chart showing calculation steps. After information on calculation is inputted in the controlling unit 11 as a recipe, a measurement is started (Step S1). The controlling unit 11 instructs photo irradiation to an optical source 7 of the optical processing unit 5 corresponding to instructing information of the recipe. The optical source 7 irradiates the substrate 3 with light through the polarizer 8. The substrate 3 is irradiated with light from the optical source 7 to multiply reflect the light corresponding to the stacked structure of the multi-layered film 4. The detector 10 detects the light through the analyzer 9 to memorize the measurement spectrum of the reflected light at a position of a measurement coordinate in the memory unit 12 (Step S2). Further, the calculating unit 13 is inputted the measurement spectrum of the reflected light and selects a group, for example, a group Aa, which is firstly instructed as an analysis object in grouping information corresponding to instruction information of the recipe in the controlling unit 11 (Step S3).

The calculating unit 13 matches theoretical spectrum calculated based on the stacked structure of the multi-layered film 4 and measurement spectrum stored in the memory unit 12 (Step S4). Values of each layers preliminarily determined by each process condition of the layer are used as a film quality, which is determined by optical constants of refractive index n and attenuation coefficient k of each of the odd-ordered layers L1, L3,-L5-L17 in the first embodiment. The theoretical spectrum and the measurement spectrum are matched using representative film thicknesses da1-da3 of each of links T1a-T3a as parameters, and the representative film thicknesses da1-da3 of the group Aa in selection of step S3 are calculated (Step S5). When a real film thicknesses di-d18 of the layers L1-L18 are defined, the representative film thicknesses da1-da3 of each of the links T1a-T3a is represented by following relations described below.

da1=(d13+d15+d17)/3 (1)

da2=(d11+d9+d7)/3 (2)

da3=(d5+d3+d1)/3 (3)

In such a manner, the representative film thicknesses da1-da3 are influenced with film parameters of the layers linked each other to be determined as a film thickness to be averagely demanded.

The calculating unit 13 selects a group, a group Ba, for example, which is secondly instructed as an analysis object in the grouping information corresponding to instruction information of the recipe in the controlling unit 11 (Step S6). The calculating unit 13 matches theoretical spectrum calculated based on the stacked structure of the multi-layered film 4 and measurement spectrum stored in the memory unit 12 (Step S7).

The calculating unit 13 conducts to match the theoretical spectrum and the measurement spectrum using representative film thicknesses da4-da6 of each of links T4a-T6a as parameters and to calculate the representative film thicknesses da4-da6 of the group Ba (step S8). The representative film thicknesses da4-da6 of each of the links T4a-T6a is represented by following relations described below.

da4=(d17+d13+d9)/3 (1)

da5=(d15+d5+d1)/3 (2)

da6=(d11+d7+d3)/3 (3)

The calculating unit 13 repeatedly conducts on the group Ca to calculate representative film thicknesses da7-da9 (Steps S9-S11). Accordingly, the representative film thicknesses da7-da9 of each of the links T7a-T9a is represented by following relations described below.

da7=(d17+d11+d5)/3 (1)

da8=(d15+d9+d3)/3 (2)

da9=(d13+d7+d1)/3 (3)

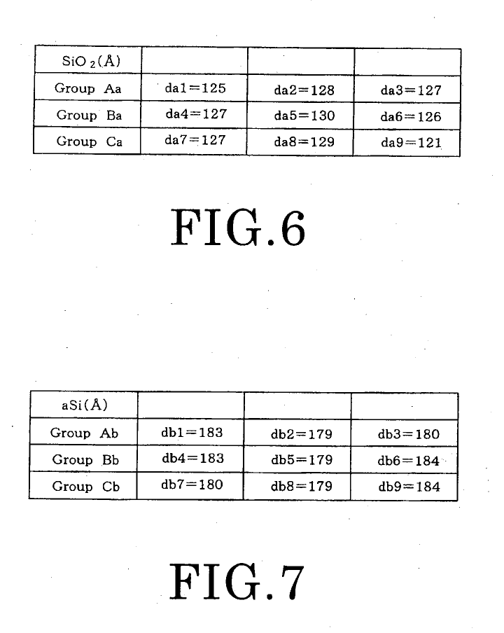

FIG. 6 is a table calculated by the calculating unit 13 showing each of the representative film thicknesses da1-da9, as an example. In FIG. 6, the values are representative film thicknesses da1-da9 when a target film thickness of the silicon oxide film in CVD process is set to be 125 Å. The representative film thicknesses da1-da9 are calculated on each of the groups Aa, Ba, Ca. The calculating unit 13 calculates film thicknesses d1, d3, d5-d17 of the odd-ordered layers L1, L3-L17 corresponding to relations to each of the representative film thicknesses da1-da9 (Step S12).

The calculating unit 13 representative film thicknesses db1-db9 of the groups Ab, Bb, Cb as the same as step S3-S12 and finally calculates film thicknesses d2, d4-d18 of the even-ordered layers L2, L4-L18 (step S13).

FIG. 7 is a table calculated by the calculating unit 13 showing each of the representative film thicknesses db1-db9 in halfway of a CVD process, as an example. In FIG. 7, the values are representative film thicknesses db1-db9 when a target film thickness of the amorphous silicon film in CVD process is set to be 175 Å. The representative film thicknesses db1-db9 are calculated on each of the groups Ab, Bb, Cb. Subsequently, each of the film thicknesses d2, d4-d18 are calculated.

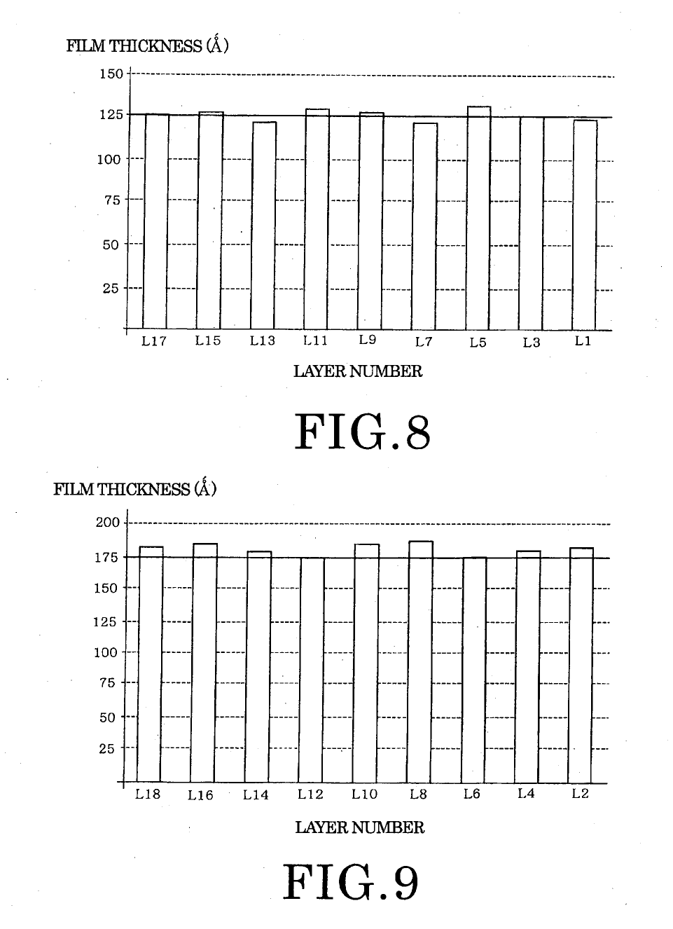

The film thicknesses d1-d18 are calculated by applying quasi-Newton method in Steps 12, 13. FIG. 8 is a graph showing the film thicknesses of each layer of the odd-ordered layers L1, L3-L17 when a process target film thickness of the silicon oxide film in CVD process is set to be 125 Å. FIG. 9 is a graph showing the film thicknesses of each layer of the even-ordered layers L2, L4-L18 when a process target film thickness of the amorphous silicon film in CVD process is set to be 175 Å.

As shown in FIG. 8, it can be recognized that the film thickness of each of layers L1-L17 in the silicon oxide films without any exceptional value can be exactly calculated. As shown in FIG. 8, the film thicknesses of each of layers L2, L4-L18 in the amorphous silicon films can be exactly calculated. In addition, calculating of the film thicknesses in Step S12 is not restricted to quasi-Newton method. Another method can be used.

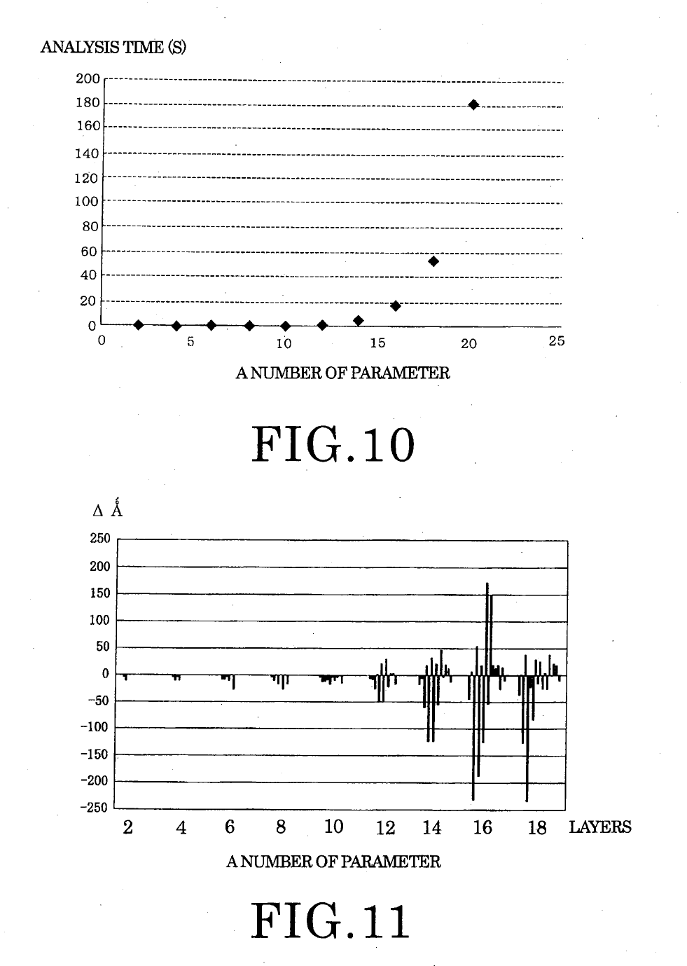

As shown in FIG. 10, a conventional method using a number of the stacked layers in the multi-layered film 4 as parameters is employed in calculating the film thicknesses to obtain analysis time. The analysis time can be confirmed to be remarkably increased when the multi-layered film 4 has over ten layers, having over ten parameters, for example, fourteen-sixteen layers.

In the method demonstrated in the first embodiment, the calculating unit 13 can conduct using six parameters, in which three groups are used in two times, in analyzing film thicknesses of the multi-layered film 4 with eighteen layers. As shown in FIG. 10, nearly not more than one second per one analysis with six parameters. Accordingly, the analysis time is confirmed to be not more than three second, even when the analysis is repeated three times.

As shown in FIG. 11, calculation accuracy of the film thicknesses of the multi-layered film 4 is examined by using a number of the stacked layers as parameters. FIG. 11 is a graph of the calculation accuracy showing the film thicknesses of the multi-layered film 4 calculated by using a conventional film thickness measurement apparatus in a condition that the target film thicknesses of each of the layers in CVD process is constant in forming the multi-layered film 4. As shown in FIG. 11, a difference from the target film thickness is remarkably extended when the multi-layered film 4 has over eight to twelve layers in which the parameters are eight to twelve, so that the calculation accuracy is conformed to be also remarkably degraded.

In the method demonstrated in the first embodiment, the calculating unit 13 calculates the film thicknesses d1-d18 of each layer of the multi-layered film 4 with eighteen layers L1-L18 using the representative film thicknesses da1-da9, db1-db9. Accordingly, the values in the graph without exceptional values from the target film thicknesses can be obtained to exactly be calculation accuracy as shown in FIGS. 8, 9, even when the multi-layered film 4 having the multi layers, for example, eighteen layers, is set to be the calculation object.

In the first embodiment, the odd-ordered layers L1, L3, L5-L17, of the stacked structure of the multi-layered film 4 are composed of the same material and have the film parameters, respectively. Each group of three groups Aa, Ba, Ca, is linked with three film parameters in the film parameters of the odd-ordered layers L1, L3, L5-L17 and the parameters linking with each of the groups are different from those linking with other groups. The representative film thicknesses da1-da9 in the links are calculated. The film thicknesses d1, d3, d5-d17 of each of the layers L1, L3, L5-L17 are calculated corresponding to the representative film thicknesses da1-da9.

The even-ordered layers L2, L4, L6-L18 of the stacked structure of the multi-layered film 4 are composed of the same material and have the film parameters, respectively. Each group of three groups Ab, Bb, Cb, is linked with three film parameters in the film parameters of the even-ordered layers L2 L4, L6-L18 and the parameters linking with each of the groups are different from those linking with other groups. The representative film thicknesses db1-db9 in the links are calculated. The film thicknesses d2, d4, d6-d18 of each of the layers L2, L4, L6-L18 are calculated corresponding to the representative film thicknesses db1-db9. In such a manner, a number of variable parameters are greatly decreased to perform analysis so that calculation with shorter time and higher accuracy can be obtained.

When the odd-ordered layers L1, L3, L5-L17 in the eighteen layers of the multi-layered film 4 are composed of the same material, for example, the silicon oxide film, three links T1a-T3a of a group Aa, for example, are set to three layers in the layers L1, L3, L5-L17, where each of the layers is not overlapped with other than one group in the grouping information. Further, each of three groups Aa, Ba, Ca includes three links, and combination of three links is different from other groups. The calculating unit 13 calculates the representative film thicknesses da1-da9 in the links of the nine links in the groups Aa, Ba, Ca. The film thickness d1, d3, d5-d17 of the odd-ordered layers L1, L3, L5-L17 are calculated corresponding to the representative film thicknesses da1-da9 obtained by the links of the groups. In a case that the even-ordered layers L2, L4, L6-L18 are composed of the same material, the amorphous silicon film, the same results described above can be obtained. In such a manner, a number of the variable parameters is greatly decreased so that analysis can be in shorter time and higher accuracy.

The calculating unit 13 changes the representative film thicknesses da1-da9 as parameters using the measurement spectrum measured only one time to calculate the theoretical spectrum, so that the calculating unit 13 matches the measurement spectrum and the theoretical spectrum to calculate each of the representative film thicknesses da1-da9. In such a manner, the measurement spectrum is fixed to be configured to calculate the representative film thicknesses da1-da9, so that a calculating error of the film thickness can be extremely controlled.

### Second Embodiment

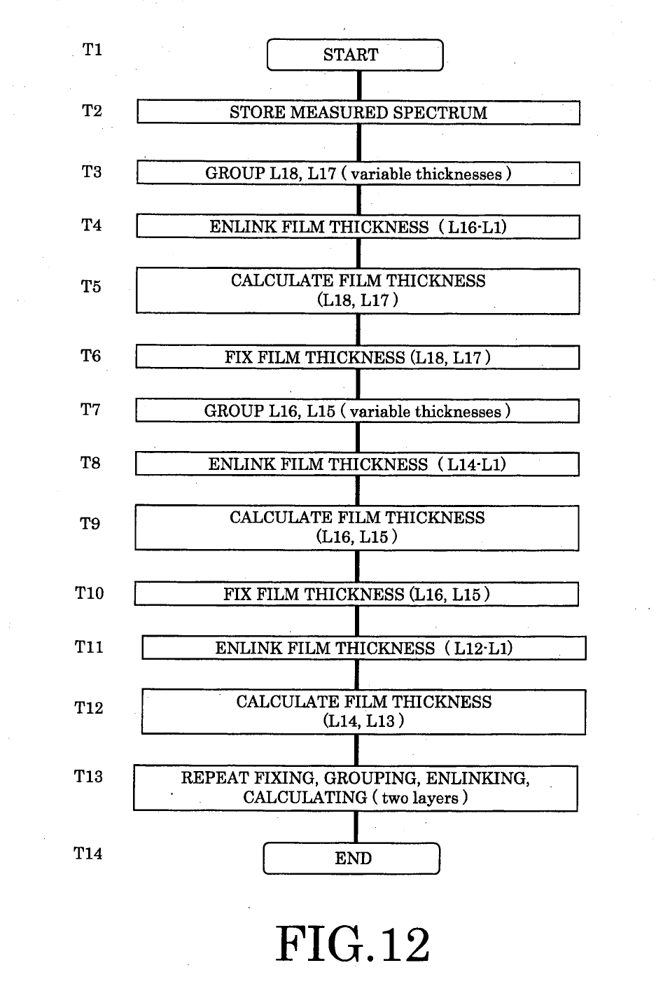

FIGS. 12-17 show a second embodiment. As a measurement system is the same as that of the first embodiment, explanation is omitted. Two kinds of films, for example, insulating films, conductive films or the like are alternately stacked to constitute a multi-layered film 4 in the second embodiment as the same as the first embodiment. The thickness of each of the films in the multi-layered film 4 is measured to be demonstrated. FIG. 12 is a flow chart showing calculation steps. After a recipe for conducting calculation is inputted, a measurement apparatus 1 conducts the calculation (step T1).

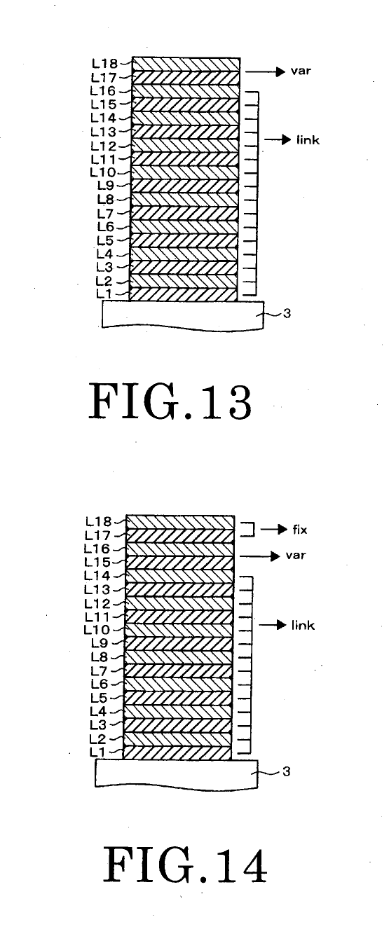

The memory unit 12 stores reflected light of a measurement coordinate position outputted from the optical processing unit 5 corresponding to recipe instruction information of a controlling unit 11 (Step T2). A calculating unit 13 makes the upmost layer 18 and a second layer 17, which is just below the upmost layer 18, set one group corresponding to the recipe instruction information of the controlling unit 11. Film thicknesses d18, d17 of the two layers in the group, respectively, are set to be variable (Step T3). Film thicknesses d16-d1 of layers L16-L1 formed under the group are linked (Step T4). In such a case, a target film thickness of each of the layers L16-L1 is different between odd-ordered and even-ordered numbers. As a result, links are set in every odd-ordered layer or every even-ordered layer. FIG. 13 shows the explanation as an image. The calculating unit 13 calculates the film thicknesses d18, d17 using the condition (Step T5). Consequently, a number of variable parameters become smaller so that the processing time can be decreased.

The calculating unit 13 fixes the film thicknesses d18, d17 of the upmost layer L18 and the second layer L17 after the calculation (Step T6). The calculating unit 13 makes film thicknesses d16, d15 of the third and fourth layers L16, L15 just below the second layer set variable (Step T7) and links film thicknesses d14-d1 of the layers L14-L1 (Step T8). As the same as described above, a target film thickness of each of the layers L14-L1 is different between odd-ordered and even-ordered numbers. As a result, links are set in every odd-ordered layer or every even-ordered layer. FIG. 14 shows the explanation as an image. The calculating unit 13 calculates the film thicknesses d16, d15 using the condition (step S9). Consequently, a number of variable parameters become smaller so that the processing time can be decreased in this state.

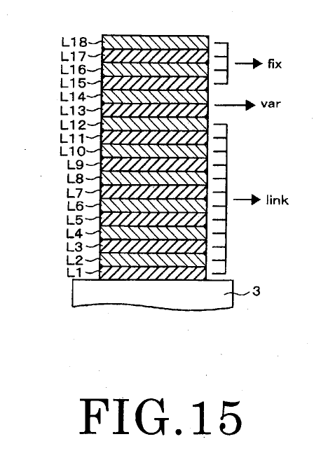

The calculating unit 13 fixes the film thicknesses d16, d15 of the layers L16, L17 after the calculation (step T10). The calculating unit 13 makes film thicknesses d14, d13 of the fifth and sixth layers L14, L13 just below the fourth layer set variable and links film thicknesses d12-d1 of the layers L12-L1 (Step T11). FIG. 15 shows the explanation as an image. The calculating unit 13 calculates the film thicknesses d14, d13 using the condition (Step T12). Next, the calculating unit 13 fixes the film thicknesses d14, d13 of the layers L16, L17 after the calculation. Further, the calculating unit 13 makes every two layers of the layers L12-L1 just below the layer L13 in order set variable, and the two layers are repeatedly processed in order (Step T13).

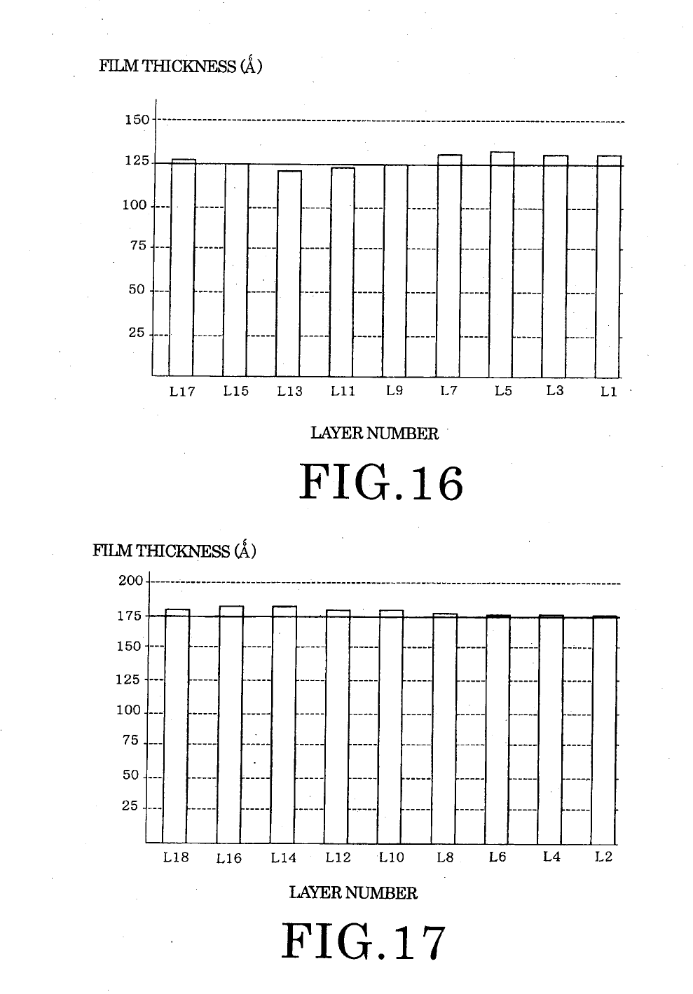

Comparison between the target film thickness and the calculated value are explained below. FIGS. 16, 17 are the calculated results showing a relation between the film thickness and each layer. The calculated results of the silicon oxide film as show in FIG. 16 are demonstrated values obtained in a condition of the target film thickness being 125 Å. The result is found to be precisely calculated without any exceptional values. The calculated results of the amorphous silicon film as show in FIG. 17 are also demonstrated values obtained in a condition of the target film thickness being 175 Å. The result is found to be precisely calculated without any exceptional values.

Specifically, the film thickness d17 of the silicon oxide film and the film thickness d18 of the amorphous silicon film are calculated to be 126 Å and 182 Å, respectively, in the calculating process of the film thicknesses d18, d17 in the Step T5, and each of the film thicknesses are nearly matched with each of the target film thicknesses.

Furthermore, the film thickness d15 of the silicon oxide film and the film thickness d16 of the amorphous silicon film are calculated to be 125 Å and 183 Å, respectively, in the calculating process of the film thicknesses d16, d15 where the film thicknesses d18, d17 are used as the fixed values and the film thicknesses d16, d15 are used as the variable values, and each of the film thicknesses are nearly matched with each of the target film thicknesses.

The processes of calculating the film thicknesses d14-d1 of the layers L14-L1 under the layers L18-L15 are omitted in detail. However, it is found that the calculated film thicknesses D14-D1 of the layers L14-L1 under the layers L18-L15 are nearly matched with the target film thicknesses.

All of the parameters of the layers under the upper layers, each having the fixed value, are linked. However, it is not restricted to the above case. The calculation can be performed in a case that the upmost layer only has the fixed value and the film parameter, for example, a film thickness of each of the layers under the upmost layer other than the third and fourth layers and the prescribed layers are linked. Namely, the measurement result on the analysis time is increased with increasing a number of the parameters as shown in FIG. 10. Therefore, the number of layers is suitably set not to greatly increase the analysis time. Further, a number of links of the film parameters can be are decreased to increase the layers in calculating the film parameters at one time in the setting range.

Analysis is repeatedly conducted in order from the upmost layer to the underlying layers to calculate the film thicknesses so that the measurement can be precisely conducted in shorter time. As compared to the conventional case, a number of the variable parameters can be decreased at one analysis and the calculation time can be decreased in repeating the analysis so that the calculation accuracy can be improved.

### OTHER EMBODIMENTS

Light can inlet to the lower layer in difficulty when a number of the layers in the stacked structure of the multi-layered film 4 is increased, as the light is refracted at the upper layers. In such a case, the wavelength of the light is used in longer wave length region by calculation to improve the calculation accuracy. A plurality of linking approaches can be used. Accordingly, it is obvious that other combination can obtain same effect as that of the embodiment described above. Accordingly, the combination is not restricted to the embodiment.

Use of ellipsometer in the inspection is demonstrated in the embodiments, light enters into the surface of the substrate 3 at an angle and the reflection light is received to be analyzed. However, an inspection method is not restricted the above case. Beam spectrum analysis method can be used. In the beam spectrum analysis method, light is entered into the substrate in nearly vertical angle and the reflection light is entered into an apparatus to measure strength of the light. In such a manner, a film thickness, film qualities, which are determined by optical constants of refractive index n and attenuation coefficient k, of the film on the substrate can be measured.

In the first embodiment, the multi-layered film 4, in which a different kind of the film is stacked on the substrate in every layer, is used for analysis. It is not restricted to the above case. A multi-layered film including not less than three layers alternately stacked can be applied to analyze, for example.

In the grouping information, the links can be set when the target film thickness is not extremely, over twice or triple, for example, changed. The links can be set when the film materials, for example, method of forming process or forming conditions such as deposition, coating, thermal oxidation, gas species, temperature or the like of silicon oxide film, for example, is not extremely changed, and can be obtained film quality, below the prescribed value of refractive index n and attenuation coefficient k, in optically nearly the same. It is desirable that the link is set to the film parameter of the film in which the film quality and the target film thickness are supposed to be identical.

In the embodiments, the film thicknesses are used as parameters, however, the film qualities can be used as parameters. Furthermore, both the film thicknesses and the film qualities can be used as parameters.

In the first embodiment, eighteen layers are divided into six groups Aa, Ba, Ca, Ab, Bb, Cb. However, a number of groupings can be arbitrarily set. A number of stacked layers in the multi-layered film can be arbitrarily set. In the embodiments, N and m equal to eighteen and three, respectively. However, it is not above case.

In the second, embodiment, the calculating unit 13 calculates the film thicknesses of the upmost layers of the two layers L18, L17, where the film thicknesses (film parameters) of the layers L16-L1 are linked. However, the film thicknesses of the upmost two layers can be calculated in order, where the film thicknesses of the layers other than the upmost two layers are linked.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A film measurement apparatus, comprising:
an optical processing unit configured to irradiate a substrate with light, the substrate including a multi-layered film thereon,
an electrical processing unit configured to be inputted measurement spectrum of reflection light reflected from the substrate, to calculate a film parameter of each of layers in a stacked structure of the multi-layered film by matching plural times between the measurement spectrum and theoretical spectrum theoretically calculated on a basis of the stacked structure, to set each of links to a film parameter of each layer having a same film in the multi-layered film, to calculate a representative film parameter in each of the links, and to calculate the film parameter of each of the layers corresponding to the representative film parameter.

2. The apparatus of claim 1, wherein
the multi-layered film includes the stacked structure in which plural kinds of films are alternately formed to be stacked as the layers.

3. The apparatus of claim 1, wherein
the multi-layered film includes the stacked structure in which two kinds of films are alternately formed to be stacked as the layers.

4. The apparatus of claim 3, wherein
the multi-layered film includes N/2 layers as a same film,
the N/2 layers are grouped into a plurality of groups, each of the groups includes m links and each of the layers is belonged to one link in the group, and each of the link in one group is not overlapped with any link in other groups, and
the electrical processing unit calculates the representative film parameter in each of the links of m×N/(2×m) of each of the groups to calculate the film parameter of each of the layers corresponding to the representative film parameter,
where N is natural number of even number, and m is a divisor of N/2, two or larger than two and smaller than N/2.

5. The apparatus of claim 1, wherein
the electrical processing unit calculates the film parameter of each of the layers corresponding to the film parameter, and changes the theoretical spectrum by changing the film parameter of each of the layers using the measurement spectrum which is obtained by one time.

6. The apparatus of claim 1, wherein
the electrical processing unit calculates a film parameter of a first layer other than the layers which are linked, fixes the film parameter of the first layer, calculates a film parameter of a second layer other than a part of the layers where the part of the layers are linked, fixes the film parameter of the second layer, and repeats the setting of the link, the calculating of the film parameter and the fixing of the film parameter to calculate a film parameter of each of the layers in the multi-layered film in order.

7. The apparatus of claim 6, wherein
the electrical processing unit calculates one or two layers from the upmost layer to lower layers in the multi-layered film in order.

8. The apparatus of claim 1, wherein
the electrical processing unit calculates the film parameter in a state that the film parameter of the layers is linked, the film parameter being same as a target film thickness.

9. A film measurement apparatus, comprising:
an optical processing unit configured to irradiate a substrate with light, the substrate including a multi-layered film including a stacked structure thereon, two kinds of films being alternately formed to be stacked as layers and N/2 layers being included as a same film in the stacked structure and being grouped into a plurality of groups, each of the groups including m links and each of the layers being belonged to one link in the group, and each of the link in one group being not overlapped with any link in other groups,
an electrical processing unit configured to be inputted measurement spectrum of reflection light reflected from the substrate, and calculating a film parameter of each of layers in a stacked structure of the multi-layered film by matching plural times between the measurement spectrum and theoretical spectrum theoretically calculated on a basis of the stacked structure, to set each of links to a film parameter of each layer having a same film in the multi-layered film, to calculate a representative film parameter in every link and the film parameter of each of the layers corresponding to the representative film parameter, to calculate the film parameter of each of the layers corresponding to the film parameter changing the theoretical spectrum by changing the film parameter of each of the layers using the measurement spectrum which is obtained by one time, and to calculate the representative film parameter in each of the links of m×N/(2×m) in each of the groups to calculate the film parameter of each of the layers corresponding to the representative film parameter,
where N is natural number of even number, and m is a divisor of N/2, two or larger than two and smaller than N/2.

10. A method of measuring a film, comprising:
calculating a film parameter of each of layers in a multi-layered film by matching theoretical spectrum and measurement spectrum, the theoretical spectrum being calculated on a basis of a stacked structure of the multi-layered film, the measurement spectrum being obtained by measurement of the multi-layered film comprising,
irradiating a substrate with light, the substrate including a multi-layered film thereon to acquire measurement spectrum of reflection light reflected from the substrate,
setting each of links to a film parameter of each layer having a same film in the multi-layered film,
calculating a representative film parameter in each of the links,
calculating the film parameter of each of the layers in the multi-layered film corresponding to the representative film parameter.

11. The method of claim 10, wherein
the multi-layered film includes a stacked structure in which plural kinds of films are alternately formed to be stacked.

12. The method of claim 10, wherein
the multi-layered film includes a stacked structure in which two kinds of films are alternately formed.

13. The method of claim 12, wherein
the multi-layered film includes N/2 layers as a same film,
the N/2 layers are grouped into a plurality of groups, each of the groups includes m links and each of the layers is belonged to one link in the group, and each of the link in one group is not overlapped with any link in other groups in the setting of each of the links to the film parameter, and
the calculating of the representative film parameter includes calculating each of the links of m×N/(2×m) in each of the groups,
where N is natural number of even number, and m is a divisor of N/2, two or larger than two and smaller than N/2.

14. The method of claim 10, wherein
the calculating the film parameter of each of the layers includes calculating the film parameter of each of the layers corresponding to the film parameter to change the theoretical spectrum by changing the film parameter of each of the layers using the measurement spectrum which is obtained by one time.

15. The method of claim 10, further comprising:
calculating a film parameter of a first layer other than the layers which are linked,
fixing the film parameter of the first layer,
calculating a film parameter of a second layer other than a part of the layers where the part of the layers are linked,
fixing the film parameter of the second layer, and
repeating the setting of the link, the calculating of the film parameter and the fixing of the film parameter to calculate a film parameter of each of the layers in the multi-layered film in order.

16. The method of claim 15, wherein
calculating one or two layers from the upmost layer to lower layers in the multi-layered film in order.

17. The method of claim 10, wherein
calculating the film parameter in a state that the film parameter of the layers is linked, the film parameter being same as a target film thickness.
